(19) United States
(12) Patent Application Publication
(10) Pub. No.: US 2005/0113493 A1
(43) Pub. Date: May 26, 2005

(54) Weatherable, homogeneously colored molding composition

(76) Inventors: Peter Persigehl, Ratingen (DE); Friedemann Paul, Bergisch Gladbach (DE); Urs-Peter Dorsch, Dormagen (DE); Hans-Jurgen Thiem, Dormagen (DE)

Correspondence Address: BAYER MATERIAL SCIENCE LLC, 100 BAYER ROAD, PITTSBURGH, PA, 15205, US

(21) Appl. No.: 10/989,366

(22) Filed: Nov. 15, 2004

(30) Foreign Application Priority Data
Nov. 18, 2003 (DE) 10353830.5
May 5, 2004 (DE) 102004022108.1

(51) Int. Cl. C08K 5/34; C08K 3/34

(52) U.S. Cl. 524/99; 524/449; 524/451

(57) ABSTRACT

A weatherable homogeneously colored thermoplastic molding composition is disclosed. The composition that contains polyalkylene terephthalate, aromatic polycarbonate,a graft polymer based on polybutadiene a graft polymer based on acrylate, a UV stabilizer and a coloring agent is suitable for making a variety of finished and semi finished products suitable for uses in the exterior or motor vehicles.

### FIELD OF THE INVENTION

The present invention relates to a thermoplastic molding composition and more particularly to a weatherable, colored and impact resistant composition.

### TECHNICAL BACKGROUND OF THE INVENTION

Impact-modified molding compositions which comprise partly crystalline polyesters, amorphous polycarbonates and graft copolymers are known. Such molding compositions are employed, for example, in the automobile sector for moldings such as bumpers, mud guards, radiator grills, headlamp screens, tailgate screens, sills, spoilers, door handles, tank caps, linings, horizontal structural components, such as engine bonnets or roof elements, door modules or the like. Prerequisites for use in motor vehicle applications are a high heat distortion temperature, high flowability in the melt, good lacquer adhesion, high resistance to chemicals, high rigidity, high dimensional stability and high toughness at low temperatures.

Moldings of impact-modified polyalkylene terephthalate/polycarbonate blends may be colored by two different methods. Traditionally, the moldings are lacquered with a coloring lacquer, the so-called base lacquer. The moldings may optionally moreover have been coated with primer and/or filler before the base lacquer. A transparent clear lacquer may furthermore optionally be applied to the base lacquer. These systems are called top-lacquered systems in the following. In top-lacquered systems the intrinsic color of the molding compositions is substantially irrelevant, since coloring is done by the base lacquer.

As an alternative to the top-lacquered systems, there are systems which are called moulded-in color systems in the following. In moulded-in color systems the color of the molding in use is determined by the intrinsic color of the molding composition, that is to say moulded-in color systems are not lacquered with a primer, filler or coloring base lacquer. However, the molded-in color systems may optionally be coated with transparent clear lacquer. The advantage of molded-in color systems lies in the saving in costs, since the working steps of priming with primer and/or fillers and of lacquering with coloring base lacquers and the associated drying operations are omitted.

The use of moldings of impact-modified polyalkylene terephthalate/polycarbonate blends in the motor vehicle exterior sector involves high requirements in respect of the weathering resistance of the material of the moldings. In this context, the resistance to photooxidation by UV irradiation (called UV stability in the following) and the resistance of the materials to hydrolyzing environmental influences (called stability to hydrolysis in the following) are of central importance.

In top-lacquered systems the harmful UV rays are largely kept back by the base lacquer. On the other hand, in molded-in color systems there is no UV-blocking function of a covering base lacquer. At best a UV-absorbing clear lacquer may hold off the majority of the harmful UV radiation in molded-in color systems. Nevertheless, molding compositions which are based on molded-in color systems must have a high UV stability, and for this reason impact modifiers based on rubbers with conjugated dienes, such as, for example, butadiene in ABS or MBS rubbers, cannot be employed alone.

Weathering-stable PC/polyester blends therefore employ, for example, acrylate rubbers, as has been described in DE-A 33 02 124.

EP-B 0 787 769 describes the use of PC/polyester blends with a combination of AES and acrylate rubbers to obtain molding compositions of improved stability to weathering and good toughness.

The stability to hydrolysis of impact-modified polyalkylene terephthalate/poly-carbonate blends is required in particular if the moldings of these materials are employed under conditions with a high outside temperature and high atmospheric humidity during the life of the motor vehicle.

U.S. Pat. No. 5,354,791 describes the use of epoxide-substituted polyalkylene terephthalate molding compositions in combination with metal-containing phosphorus compounds in impact-modified polyalkylene terephthalate/poly-carbonate blends to improve the stability to hydrolysis. The improvement in the stability to hydrolysis is described here by the small change in the melt viscosity after storage of the material at 110° C. in water in an autoclave. The UV resistance and the nature of the surface are not referred to in U.S. Pat. No. 5,354,791.

In molded-in color systems, however, in addition to weathering resistance the ability to be colored homogeneously is also of very great importance. Precisely in the case of impact-modified PC/polyester blends with weathering-resistant acrylate impact modifiers, in the case of injection moldings undesirable color inhomogeneities occur, in which periodically recurring regions colored less, which have an optically brighter effect, with more deeply colored regions, which have an optically darker or more color-intensive effect, are formed perpendicular to the direction of flow during the injection molding operation, these are referred to as tiger stripes. For moldings which are perceived visually by the user in the end use, such as, for example, the motor vehicle exterior skin—such as e.g. mud guards, bumpers, tailgates, headlamp screens, spoilers, air intake grills, engine bonnets, car roofs—motor vehicle interiors, electrical housings or electronics housings, these tiger stripe effects are unacceptable.

The object was to develop homogeneously colored impact-modified polyalkylene terephthalate/polycarbonate molding compositions of improved weathering resistance for uses in so-called molded-in color systems. Increased requirements in respect of homogeneous coloring of the molding compositions or moldings are imposed on molded-in color systems, since the coloring of the molding composition is responsible at the same time for the color appearance of the finished molding in use.

### SUMMARY OF THE INVENTION

A weatherable homogeneously colored thermoplastic molding composition is disclosed. The composition that contains polyalkylene terephthalate, aromatic polycarbonate, a graft polymer based on polybutadiene a graft polymer based on acrylate , a UV stabilizer and a coloring agent is suitable for making a variety of finished and semi finished products suitable for uses in the exterior or motor vehicles.

### DETAILED DESCRIPTION OF THE INVENTION

It has now been found, surprisingly, that colored molding compositions based on polyalkylene terephthalate/polycarbonate achieve the object described if at least two different systems based on graft copolymer compositions based on acrylates on the one hand and based on butadiene on the other hand are employed as the impact modifier in combination with stabilizers for increasing the UV resistance and for improving the resistance to hydrolysis. The moldings from the compositions according to the invention are distinguished by a homogeneous appearance and homogeneous color impression of the surface and excellent stability to weathering. The molding compositions according to the invention are moreover distinguished by a high heat distortion point, good flowability in the melt, good lacquer adhesion, high resistance to chemicals, high rigidity, high dimensional stability and high toughness at low temperatures.

The invention provides compositions comprising
A) 4 to 80 parts by wt., preferably 10 to 60 parts by wt., particularly preferably 12 to 50 parts by wt., in particular 19 to 40 parts by wt. of at least one polyalkylene terephthalate, preferably a polyethylene terephthalate or a polybutylene terephthalate, particularly preferably a polybutylene terephthalate,
B) 10 to 90 parts by wt., preferably 20 to 80 parts by wt., particularly preferably 25 to 60 parts by wt, in particular 30 to 60 parts by wt. of at least one aromatic polycarbonate,
C) 1.5 to 30 parts by wt., preferably 3 to 25 parts by wt., particularly preferably 4 to 20 parts by wt., in particular 5 to 15 parts by wt. of at least one graft polymer based on rubber-elastic olefinically unsaturated olefin (co)polymers preferably polybutadiene as the rubber component,
D) 1.5 to 30 parts by wt., preferably 3 to 25 parts by wt., particularly preferably 4 to 20 parts by wt., in particular 5 to 15 parts by wt. of at least one graft polymer based on acrylate as the rubber component,
E) 0.01 to 5 parts by wt., preferably 0.05 to 3 parts by wt., particularly preferably 0.1 to 1 part by wt. of a UV stabilizer,
F) 0.01 to 10 parts by wt., preferably 0.05 to 6 parts by wt., particularly preferably 0.1 to 3 parts by wt. of coloring agent,
G) 0 to 5 parts by wt., preferably 0.05 to 3 parts by wt., particularly preferably 0.1 to 2 parts by wt. of hydrolysis stabilizers, preferably based on epoxide compounds,
H) 0 to 54 parts by wt., preferably 3 to 34 parts by wt., particularly preferably 6 to 25, in particular 8 to 21 parts by wt. of at least one particulate mineral filler,
I) 0 to 10 parts by wt., preferably 0.05 to 3 parts by wt., particularly preferably 0.1 to 0.9 part by wt. of further additives.

According to the invention, the compositions comprise as component A one or a mixture of two or more different polyalkylene terephthalates. Polyalkylene terephthalates in the context of the invention are polyalkylene terephthalates which are derived from terephthalic acid (or its reactive derivatives) and alkanediols, for example based on ethylene glycol, propylene glycol or butanediol. According to the invention, preferably polybutylene terephthalate, polytrimethylene terephthalate and/or polyethylene terephthalate, particularly preferably polybutylene terephthalate and/or polyethylene terephthalate, most preferably polybutylene terephthalate are employed as component A.

Polyalkylene terephthalates in the context of the invention are reaction products of aromatic dicarboxylic acids or their reactive derivatives (e.g. dimethyl esters or anhydrides) and aliphatic, cycloaliphatic or araliphatic diols and mixtures of these reaction products.

Preferred polyalkylene terephthalates may be prepared from terephthalic acid (or its reactive derivatives) and aliphatic or cycloaliphatic diols having 2 to 10 C atoms by known methods (Kunststoff-Handbuch, vol. VIII, p. 695 et seq., Karl-Hanser-Verlag, Munich 1973).

Preferred polyalkylene terephthalates contain at least 80 mol %, preferably 90 mol %, based on the dicarboxylic acid, of terephthalic acid radicals and at least 80 mol %, preferably at least 90 mol %, based on the diol component, of radicals of ethylene glycol and/or propane-1,3-diol and/or butane-1,4-diol.

The preferred polyalkylene terephthalates may contain, in addition to terephthalic acid radicals, up to 20 mol % of radicals of other aromatic dicarboxylic acids having 8 to 14 C atoms or aliphatic dicarboxylic acids having 4 to 12 C atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid or cyclohexanedicarboxylic acid.

The preferred polyalkylene terephthalates may contain, in addition to radicals of ethylene glycol or propane-1,3-diol or butane-1,4-diol, up to 20 mol % of other aliphatic diols having 3 to 12 C atoms or cycloaliphatic diols having 6 to 21 C atoms, e.g. radicals of propane-1,3-diol, 2-ethylpropane-1,3-diol, neopentylglycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and -1,6-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane.

The polyalkylene terephthalates may be branched by incorporation of relatively small amounts of 3- or 4-hydric alcohols or 3- or 4-basic carboxylic acids, such as are described e.g. in DE-A 19 00 270 and U.S. Pat. No. 3,692,744. Examples of preferred branching agents are trimesic acid, trimellitic acid, trimethylolethane and -propane and pentaerythritol.

It is advisable to use not more than 1 mol % of the branching agent, based on the acid component.

Polyalkylene terephthalates which have been prepared solely from terephthalic acid and reactive derivatives thereof (e.g. dialkyl esters thereof) and ethylene glycol and/or propane-1,3-diol and/or butane-1,4-diol (polyethylene terephthalate and polybutylene terephthalate) and mixtures of these polyalkylene terephthalates are particularly preferred.

Copolyesters which are prepared from at least two of the abovementioned acid components and/or from at least two of the abovementioned alcohol components are also preferred polyalkylene terephthalates, and particularly preferred copolyesters are poly-(ethylene glycol/butane-1,4-diol) terephthalates.

The polyalkylene terephthalates in general have an intrinsic viscosity of approx. 0.4 to 1.5, preferably 0.5 to 1.3, in each case measured in phenol/o-dichloro-benzene (1:1 parts by wt.) at 25° C.

The polyalkylene terephthalates to be employed according to the invention may preferably also be employed in a mixture with other polyesters and/or further polymers. Particularly preferably, mixtures of polyalkylene terephthalates with other polyesters, very particularly preferably mixtures of polybutylene terephthalate with polyethylene terephthalate are employed.

Conventional additives, such as e.g. mould release agents, stabilizers and/or flow agents, can be added to the mixtures in the melt or applied to the surface.

According to the invention, the compositions according to the invention comprise as component B a polycarbonate or a mixture of polycarbonates.

Preferred polycarbonates are those homopolycarbonates and copolycarbonates based on the dihydroxy compounds of the general formula (I)
HO—Z—OH (I)
wherein Z is a divalent organic radical having 6 to 30 C atoms which contains one or more aromatic groups.

Dihydroxy compounds of the formula (Ia) 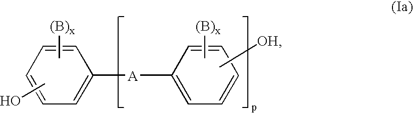
wherein
A represents a single bond, C₁-C₅-alkylene, C₂-C₅-alkylidene, C₅-C₆-cycloalkylidene, —O—, —SO—, —Co—, —S—, —SO₂—, C₆-C₁₂-arylene, on to which further aromatic rings optionally containing heteroatoms may be fused, or a radical of the formula (II) or (III) 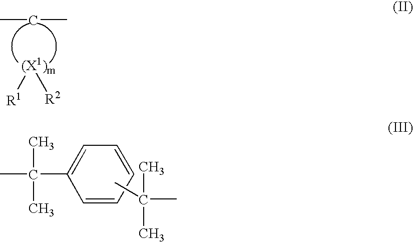
   and
B represents in each case C₁-C₁₂-alkyl, preferably methyl, or halogen, preferably chlorine and/or bromine,
x in each case independently of one another, represents 0, 1 or 2,
p represents 1 or 0,
R¹ and R² may be chosen individually for each X¹ and independently of one another represent hydrogen or C₁-C₆-alkyl, preferably hydrogen, methyl or ethyl,
X¹ represents carbon and
m represents an integer from 4 to 7, preferably 4 or 5, with the proviso that on at least one atom X¹ R¹ and R² simultaneously represent alkyl are preferred.

Examples of dihydroxy compounds according to the general formula (I) are bisphenols which belong to the following groups: dihydroxydiphenyls, bis-(hydroxyphenyl)-alkanes, bis-(hydroxyphenyl)-cycloalkanes, indanebisphenols, bis-(hydroxyphenyl)sulfides, bis-(hydroxyphenyl)ethers, bis-(hydroxyphenyl) ketones, bis-(hydroxyphenyl)sulfones, bis-(hydroxyphenyl)sulfoxides and α,α′-bis-(hydroxyphenyl)-diisopropylbenzenes.

Derivatives of the dihydroxy compounds mentioned which are accessible, for example, by alkylation or halogenation on the aromatic rings of the bisphenols mentioned are also examples of dihydroxy compounds according to the general formula (I).

Examples of dihydroxy compounds according to the general formula (I) are, in particular, the following compounds: hydroquinone, resorcinol, 4,4′-dihydroxy-diphenyl, bis-(4-hydroxyphenyl)sulfofide, bis-(4-hydroxyphenyl)sulfone, bis-(3,5-dimethyl-4-hydroxyphenyl)-methane, bis-(3,5-dimethyl-4-hydroxyphenyl)sulfone, 1,1-bis-(3,5-dimethyl-4-hydroxyphenyl)-p/m-diisopropylbenzene, 1,1-bis-(4-hydroxyphenyl)-1-phenyl-ethane, 1,1-bis-(3,5-dimethyl-4-hydroxy-phenyl)-cyclohexane, 1,1-bis-(4-hydroxyphenyl)-3-methylcyclohexane, 1,1-bis-(4-hydroxyphenyl)-3,3-dimethylcyclohexane, 1,1-bis-(4-hydroxyphenyl)-4-methylcyclohexane, 1,1-bis-(4-hydroxyphenyl)-cyclohexane, 1,1-bis-(4-hydroxy-phenyl)-3,3,5-trimethylcyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxyphenyl)-propane (i.e. bisphenol A), 2,2-bis-(3-chloro-4-hydroxyphenyl)-propane, 2,2-bis-(3,5-dibromo-4-hydroxy-phenyl)-propane, 2,4-bis-(4-hydroxyphenyl)-2-methylbutane, 2,4-bis-(3,5-dimethyl-4-hydroxyphenyl)-2-methylbutane, α,α′-bis-(4-hydroxyphenyl)-o-diisopropylbenzene, α,α,′-bis-(4-hydroxyphenyl)-m-diisopropylbenzene (i.e. bisphenol M), α,α′-bis-(4-hydroxyphenyl)-p-diisopropylbenzene and indanebisphenol.

Particularly preferred polycarbonates are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The dihydroxy compounds described, according to the general formula (I), may be prepared by known processes, e.g. from the corresponding phenols and ketones.

The dihydroxy compounds mentioned and processes for their preparation belong to the prior art., thus also 1,1-bis-(4-hydroxyphenyl)-3,3,5-trimethylcyclohexane and the indanebisphenols. Indanebisphenols may be prepared, for example, from isopropenylphenol or derivatives thereof, or from dimers of isopropenylphenol or derivatives thereof in the presence of a Friedel-Crafts catalyst in organic solvents.

Polycarbonates may be prepared by known processes. Suitable processes for the preparation of polycarbonates are, for example, preparation from dihydroxy compounds with phosgene by the phase boundary process or from bisphenols with phosgene by the process in a homogeneous phase, the so-called pyridine process, or from bisphenols with carbonic acid esters by the melt transesterification process. These preparation processes are described e.g. in H. Schnell, “Chemistry and Physics of Polycarbonates”, Polymer Reviews, volume 9, p. 31-76, Interscience Publishers, New York, London, Sydney, 1964.

The melt transesterification process is described, in particular, in H. Schnell, “Chemistry and Physics of Polycarbonates”, Polymer Reviews, volume 9, p. 44 to 51, Interscience Publishers, New York, London, Sydney, 1964.

Raw materials and auxiliary substances with a low content of impurities are preferably employed in the preparation of polycarbonate. In the preparation by the melt transesterification process in particular, the bisphenols employed and the carbonic acid derivatives employed should be as free as possible from alkali metal ions and alkaline earth metal ions. Raw materials of such purity are obtainable, for example, by recrystallizing, washing or distilling the carbonic acid derivatives, for example carbonic acid esters, and the bisphenols.

The polycarbonates to be employed according to the invention preferably have a weight-average molecular weight (\overline{M}_{w}), which may be determined e.g. by ultracentrifugation or scattered light measurement, of 10,000 to 200,000 g/mol. They particularly preferably have a weight-average molecular weight of 12,000 to 80,000 g/mol, especially preferably 20,000 to 35,000 g/mol.

The average molecular weight of the polycarbonates to be employed according to the invention may be established, for example, in a known manner by an appropriate amount of chain terminators. The chain terminators may be employed individually or as a mixture of various chain terminators.

Suitable chain terminators are both monophenols and monocarboxylic acids. Suitable monophenols are e.g. phenol, p-chlorophenol, p-tert-butylphenol, cumylphenol or 2,4,6-tribromophenol, and long-chain alkylphenols, such as e.g. 4-(1,1,3,3-tetramethylbutyl)-phenol, or monoalkylphenols or dialkylphenols having a total of 8 to 20 C atoms in the alkyl substituents, such as e.g. 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halogenobenzoic acids.

Preferred chain terminators are phenol, p-tert-butylphenol, 4-(1,1,3,3-tetramethylbutyl)-phenol and cumylphenol.

The amount of chain terminators to be employed is preferably between 0.25 and 10 mol %, based on the total of the particular bisphenols employed.

The polycarbonates to be employed according to the invention may be branched in a known manner, and in particular preferably by incorporation of branching agents which are trifunctional or more than trifunctional. Suitable branching agents are e.g. those having three or more than three phenolic groups or those having three or more than three carboxylic acid groups.

Branching agents which are suitable according to the invention are, for example, phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenyl-methane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl) terephthalate, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene and 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenyl)-1,3,5-triisopropylbenzene.

Branching agents which are preferably to be employed are 1,1,1-tris-(4-hydroxyphenyl)-ethane and 3,3-bis-(3-methyl-4-hydroxyphenyl)-2-oxo-2,3-dihydroindole.

The amount of the branching agents optionally to be employed is preferably 0.05 mol % to 2 mol %, based on the moles of dihydroxy compounds employed.

In the case of preparation of the polycarbonate by the phase boundary process, for example, the branching agents may be initially introduced into the aqueous alkaline phase with the dihydroxy compounds and the chain terminators, or they may be added as a solution in an organic solvent, together with the carbonic acid derivatives. In the case of the transesterification process, the branching agents are preferably metered in together with the dihydroxyaromatics or bisphenols.

Catalysts which are preferably to be employed in the preparation of polycarbonate by the melt transesterification process are the ammonium salts and phosphonium salts known from the literature.

Copolycarbonates may also be used according to the invention. Copolycarbonates in the context of the invention are, in particular, polydiorganosiloxane/poly-carbonate block copolymers, the weight-average molecular weight (\overline{M}_{w}) of which is preferably 10,000 to 200,000 g/mol, particularly preferably 20,000 to 80,000 g/mol (determined by gel permeation chromatography after prior calibration by light scattering measurement or ultracentrifugation). The content of aromatic carbonate structural units in the polydiorganosiloxane/polycarbonate block copolymers is preferably 75 to 97.5 wt. %, particularly preferably 85 to 97 wt. %. The content of polydiorganosiloxane structural units in the polydiorganosiloxane/polycarbonate block copolymers is preferably 25 to 2.5 wt. %, particularly preferably 15 to 3 wt. %. The polydiorganosiloxane/poly-carbonate block copolymers may be prepared, for example, starting from polydiorganosiloxanes containing α,ω-bishydroxyaryloxy end groups and having an average degree of polymerization of preferably Pₙ=5 to 100, particularly preferably Pₙ=20 to 80.

The polydiorganosiloxane/polycarbonate block polymers may also be a mixture of polydiorganosiloxane/polycarbonate block copolymers with conventional polysiloxane-free thermoplastic polycarbonates, the total content of polydiorganosiloxane structural units in this mixture preferably being 2.5 to 25 wt. %.

Such polydiorganosiloxane/polycarbonate block copolymers are characterized in that they contain in the polymer chain on the one hand aromatic carbonate structural units (I) and on the other hand polydiorganosiloxanes (2) containing aryloxy end groups 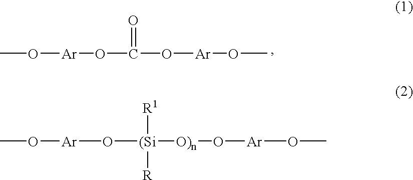
wherein
Ar are identical or different difunctional aromatic radicals and
R and R¹ are identical or different and denote linear alkyl, branched alkyl, alkenyl, halogenated linear alkyl, halogenated branched alkyl, aryl or halogenated aryl, preferably methyl, and
n denotes the average degree of polymerization of preferably 5 to 100, particularly preferably 20 to 80.

Alkyl in the above formula (2) is preferably C₁-C₂₀-alkyl, alkenyl in the above formula (2) is preferably C₂-C₆-alkenyl; aryl in the above formulae (1) and (2) is preferably C₆-C₁₄-aryl. Halogenated in the above formula means partly or completely chlorinated, brominated or fluorinated.

Examples of alkyls, alkenyls, aryls, halogenated alkyls and halogenated aryls are methyl, ethyl, propyl, n-butyl, tert-butyl, vinyl, phenyl, naphthyl, chloromethyl, perfluorobutyl, perfluorooctyl and chlorophenyl.

Such polydiorganosiloxane/polycarbonate block copolymers and their preparation are known.

Preferred polydiorganosiloxane/polycarbonate block copolymers may be prepared e.g. by reacting polydiorganosiloxanes containing α,ω-bishydroxyaryloxy end groups together with other bisphenols, optionally with the co-use of branching agents in the conventional amounts, e.g. by the two-phase boundary process (as described, for example, in H. Schnell, “Chemistry and Physics of Polycarbonates”, Polymer Reviews, volume 9, p. 31-76, Interscience Publishers, New York, London, Sydney, 1964). The polydiorganosiloxanes containing α,ω-bishydroxy-aryloxy end group used as educts for this synthesis and their preparation are described, for example, in U.S. Pat. No. 3,419,634.

Conventional additives, such as e.g. mould release agents, may be admixed to the polycarbonates in the melt or applied to the surface. The polycarbonates to be used preferably already comprise mould release agents before compounding with the other components of the molding compositions according to the invention.

According to the invention, a graft polymer or a mixture of two or more graft copolymers which are obtained by grafting polymerization of at least one vinyl monomer on to a graft base based on olefinically unsaturated olefin polymers or olefinically unsaturated olefin copolymers are employed as component C).

According to the invention, graft polymers of
C1) 5 to 95 wt. %, preferably 10 to 80 wt. %, in particular 20 to 50 wt. % of at least one vinyl monomer on
C2) 95 to 5 wt. %, preferably 90 to 20, in particular 80 to 20 wt. % of one or more graft bases having glass transitions temperatures of the rubber component of <−10° C., preferably <−20° C., particularly preferably <−30° C. and based on rubber-elastic olefinically unsaturated olefin (co)polymers.
   are employed as component C).

The graft base C2) in general has an average particle size (d₅₀ value) of 0.05 to 5 μm, preferably 0.10 to 2 μm, particularly preferably 0.15 to 1 μm.

Monomers C1) are preferably mixtures
C1.1) of 50 to 99 parts by wt., preferably 60 to 80 parts by wt. of vinylaromatics and/or vinylaromatics substituted on the nucleus, such as styrene, α-methylstyrene, p-methylstyrene or p-chlorostyrene, and/or acrylic acid (C₁-C₈)-alkyl esters and/or methacrylic acid (C₁-C₈)-alkyl esters, such as methyl methacrylate and ethyl methacrylate, and
C1.2) 1 to 50 parts by wt., preferably 40 to 20 parts by wt. of vinyl cyanides (unsaturated nitriles, such as acrylonitrile and methacrylonitrile) and/or (meth)acrylic acid (C₁-C₈)-alkyl esters, such as methyl methacrylate, n-butyl acrylate and t-butyl acrylate, and/or derivatives, such as anhydrides and imides, of unsaturated carboxylic acids, for example maleic anhydride and N-phenylmaleimide.

Particularly preferred monomers C1.1) are chosen from at least one of the monomers styrene, α-methylstyrene and methyl methacrylate, and particularly preferred monomers C1.2) are chosen from at least one of the monomers acrylonitrile, maleic anhydride and methyl methacrylate.

Particularly preferred monomers are C1.1 styrene and C1.2 acrylonitrile and C1.1 styrene and C1.2 methyl methacrylate.

Preferred graft bases C2 are diene rubbers (e.g. based on butadiene, isoprene etc.) or mixtures of diene rubbers or copolymers of diene rubbers or mixtures thereof with further copolymerizable monomers (e.g. according to C1.1 and C1.2), with the proviso that the glass transition temperature of component C2 is below <−10° C., preferably <−20° C. particularly preferably <−30° C. and that the graft base has olefinically unsaturated groups.

Pure polybutadiene rubber is particularly preferably employed.

Particularly preferred polymers C are e.g. ABS polymers (emulsion, bulk and suspension ABS) such as are known to the expert from the literature, for example from Ullmann, Enzyklopadie der Technischen Chemie, vol. 19 (1980), p. 280 et seq. The gel content of the graft base C2 is at least 30 wt. %, preferably at least 40 wt. % (measured in toluene).

The graft copolymers C) are prepared by free-radical polymerization, e.g. by emulsion, suspension, solution or bulk polymerization, preferably by emulsion or bulk polymerization.

ABS polymers which are prepared by redox initiation with an initiator system of organic hydroperoxide and ascorbic acid in accordance with U.S. Pat. No. 4,937,285 are also particularly suitable graft rubbers.

Since as is known in the grafting reaction the grafting monomers are not necessarily completely grafted on to the graft base, according to the invention graft polymers C) are also understood as meaning those products which are obtained by (co)polymerization of the grafting monomers in the presence of the graft base and are co-obtained during the working up.

Products known to the expert as MBS rubbers, such as e.g. are marketed by Rohm und Haas under the name Paraloid® EXL 2600, Paraloid EXL 2650 or Paraloid® EXL 2691 and which are described e.g. in EP-A 0 985 682, are particularly preferred as polymers C).

According to the invention, one or a mixture of two or more graft copolymers which are obtained by grafting polymerization of at least one vinyl monomer on to a graft base based on rubber-elastic acrylate polymers or on rubber-elastic acrylate copolymers are employed as component D).

According to the invention, graft polymers of
D1) 5 to 95 wt. %, preferably 10 to 80 wt. %, in particular 20 to 50 wt. % of at least one vinyl monomer on
D2) 95 to 5 wt. %, preferably 90 to 20, in particular 80 to 20 wt. % of one or more graft bases having glass transitions temperatures of the rubber component of <10° C., preferably <0° C., particularly preferably <−10° C. and based on rubber-elastic acrylate polymers or acrylate copolymers
   are employed as component D).

The graft base D2) in general has an average particle size (d₅₀ value) of 0.05 to 5 μm, preferably 0.10 to 2 μm, particularly preferably 0.15 to 1 μm.

Monomers D1) are preferably mixtures
D1.1) of 50 to 99, preferably 60 to 80 parts by wt. of vinylaromatics and/or vinylaromatics substituted on the nucleus, such as styrene, α-methylstyrene, p-methylstyrene or p-chlorostyrene, and/or acrylic acid (C₁-C₈)-alkyl esters and/or methacrylic acid (C₁-C₈)-alkyl esters, such as methyl methacrylate and ethyl methacrylate, and
D1.2) 1 to 50, preferably 40 to 20 parts by wt. of vinyl cyanides (unsaturated nitrites, such as acrylonitrile and methacrylonitrile) and/or (meth)acrylic acid (C₁-C₈)-alkyl esters, such as methyl methacrylate, n-butyl acrylate and t-butyl acrylate, and/or derivatives, such as anhydrides and imides, of unsaturated carboxylic acids, for example maleic anhydride and N-phenylmaleimide.

Particularly preferred monomers D1.1) are chosen from at least one of the monomers styrene, α-methylstyrene and methyl methacrylate, and particularly preferred monomers D1.2) are chosen from at least one of the monomers acrylonitrile, maleic anhydride and methyl methacrylate. Particularly preferred monomers are D1.1 styrene and D1.2 acrylonitrile.

Suitable acrylate rubbers according to D2 of the polymers D are, preferably, polymers of acrylic acid alkyl esters, optionally with up to 40 wt. %, based on D2, of other polymerizable, ethylenically unsaturated monomers. Preferred polymerizable acrylic acid esters include C₁-C8-alkyl esters, for example the methyl, ethyl, butyl, n-octyl and 2-ethylhexyl ester, halogenoalkyl esters, preferably halogeno-C₁-C₈-alkyl esters, such as chloroethyl acrylate, and mixtures of these monomers.

For crosslinking, monomers having more than one polymerizable double bond may be copolymerized. Preferred examples of crosslinking monomers are esters of unsaturated monocarboxylic acids having 3 to 8 C atoms and unsaturated monohydric alcohols having 3 to 12 C atoms, or saturated polyols having 2 to 4 OH groups and 2 to 20 C atoms, such as e.g. ethylene glycol dimethacrylate and allyl methacrylate; polyunsaturated heterocyclic compounds, such as e.g. trivinyl and triallyl cyanurate; polyfunctional vinyl compounds, such as di- and trivinylbenzenes, dicyclopentadiene and 5-ethylidenenorbomene; and also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine and triallylbenzenes. The amount of the crosslinked monomers is preferably 0.02 to 5, in particular 0.05 to 2 wt. %, based on the graft base D2.

In the case of cyclic crosslinking monomers having at least 3 ethylenically unsaturated groups, it is advantageous to limit the amount to below 1 wt. % of the graft base D2.

Preferred “other” polymerizable, ethylenically unsaturated monomers which may optionally be used for the preparation of the graft base D2, in addition to the acrylic acid esters, are e.g. acrylonitrile, styrene, α-methylstyrene, acrylamides, vinyl C₁-C₆-alkyl ethers and methyl methacrylate. Preferred acrylate rubbers as the graft base D2 are emulsion polymers which have a gel content of at least 60 wt. %. The preparation of the graft base D2 may be carried out in one step or in several steps. A mixture of various graft bases according to the description may also be employed for the grafting reaction. In particular, various graft bases which differ in average particle size may also be employed.

ASA rubbers such as are described e.g. in WO 2000046296, in EP 0960145 or in DE 4229913 are particularly preferred as component D) according to the invention.

The compositions according to the invention comprise as component E) known UV stabilizers, such as are described, for example, in Gächter, Müller, Kunststoff-Additive, 3rd edition, Hanser-Verlag, Munich, Vienna, 1989 and in the Plastics Additives Handbook, 5th edition, Hanser-Verlag, Munich, 2001, p. 97-137, 141-154, 178-183, 188-192, 369-372 and 389-394. The UV stabilizers may be employed by themselves or in a mixture or in the form of masterbatches.

Preferred UV stabilizers which are to be employed according to the invention are sterically hindered phenols, sterically hindered amines (HALS=hindered amine light stabilizer), hydroquinones, aromatic secondary amines, such as diphenylamines, substituted resorcinols, salicylates, benzotriazoles and benzophenones, and variously substituted representatives of these groups and mixtures thereof.

Sterically hindered amines of the HALS type, benzotriazoles, benzotriazines and benzopyrimidines are particularly preferred.

The sterically hindered amines of the HALS type which are preferably to be employed may be derived from the general structure shown in (3)

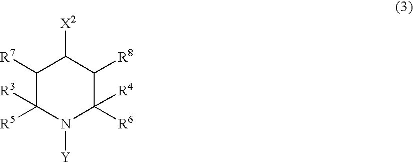

In this formula, the radicals may be, in each case independently of one another:
Y: H, acyl, O radical, alkyl, alkenyl, alkoxyalkyl, arylalkyl,
X²: —OR, NR₂, maleimide,
R⁷ and R⁸ independently of one another=H, alkyl, alkenyl, arylalkyl, preferably=H
R³, R⁴, R⁵, R⁶ independently of one another H, alkyl, phenyl, alkylaryl, aromatic heterocyclic radical containing oxygen, sulfur or nitrogen; preferably R³-R⁶ are methyl

The HALS stabilizers which are preferably to be employed are described, for example, in U.S. Pat. No. 4895901, U.S. Pat. No. 4210612 and U.S. Pat. No. 5015682.

The benzotriazoles which are preferably to be employed may be derived generally from the structure shown in (4).

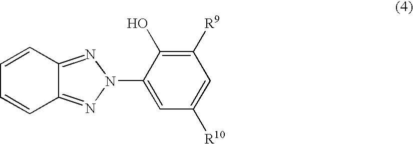

In this formula, R⁹ and R¹⁰ may be chosen independently of one another from the group consisting of H, alkyl (in particular methyl, ethyl, propyl), cycloalkyl, halogen, haloalkyl, alkoxy, alkylene, aryl, alkyl-aryl or a combination of these.

Particularly preferably, R⁹=R¹⁰=(2-phenyl)-isopropyl, R⁹=H and R¹⁰=2-(2,4,4-trimethyl)-pentyl, R⁹=H and R¹⁰=methyl, R⁹=R¹⁰=t-butyl, R⁹=t-butyl and R¹⁰=methyl, R⁹=R¹⁰=2-(2-methyl)-butyl, R⁹=iso-butyl and R¹⁰=2-(2,4,4-trimethyl)-pentyl.

The benzotriazoles described which are preferably to be employed according to the invention are marketed, for example, by Ciba Spezialchemikalien, Basle, Switzerland under the commercial product name Tinuvin®.

The hydroxyphenyltriazine and -pyrimidine UV stabilizers which are preferably to be employed consist of two phenyl groups and one resorcinol group, which are bonded to a triazine or pyrimidine ring, as described in U.S. Pat. No. 6,239,276 and U.S. Pat. No. 5,597,854. The hydroxyphenyltriazines and -pyrimidines which are preferably to be employed may be derived generally from the general structure shown in (5).

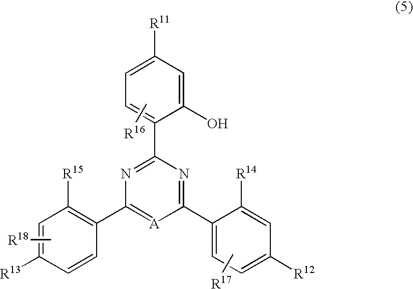

In formula (5), A may be N or CH and R¹¹ to R¹⁸ independently of one another may be chosen from the group consisting of H, alkyl (in particular methyl, ethyl, propyl), cycloalkyl, halogen, haloalkyl, alkoxy, alkylene, aryl, alkyl-aryl or combinations of these.

Examples of commercially available representatives of the hydroxyphenyltriazines which are preferably to be employed are Tinuvin® 1577 (CAS number 147315-50-2, Ciba Spezialchemikalien, Basle, Switzerland) or Cyasorb® UV 1164 (Cyctec Industries).

The compositions according to the invention comprise as component F) conventional coloring agents and/or pigments, such as e.g. titanium dioxide, ultramarine blue, iron oxide, carbon black, phthalocyanines, quinacridones, perylenes, nigrosin and anthraquinones and derivatives thereof. The coloring agents described in U.S. Pat. No. 6,476,158 are also suitable, in particular, for improving the gloss after weathering. The coloring agents and/or pigments may be added as the substance or as a masterbatch, for example in component A), component B), component C), polyethylene, polypropylene, waxes or paraffin.

The coloring agents to be employed according to the invention are also described, for example, in Plastics Additives Handbook, 5th edition, Hanser-Verlag, Munich, 2001, p. 822-850.

According to the invention, the compositions may comprise as comonent G) at least difunctional, low molecular weight and oligomeric compounds which have at least one epoxide group.

Preferred epoxide-containing compounds as component G are, generally:
1. Polyglycidyl or poly-(β-methylglycidyl) ethers obtainable by reaction of a compound having at least two free alcoholic or phenolic hydroxyl groups and/or phenolic hydroxyl groups and a suitably substituted epichlorohydrin under alkaline conditions, or in the presence of an acidic catalyst with subsequent treatment with alkali.

Ethers of this type are derived, for example, from acyclic alcohols, such as ethylene glycol, diethylene glycol and higher poly-(oxyethylene)glycols, propane-1,2-diol or poly-(oxypropylene)glycols, propane-1,3-diol, butane-1,4-diol, poly-(oxytetramethylene)glycols, pentane-1,5-diol, hexane-1,6-diol, hexane-2,4,6-triol, glycerol, 1,1,1-trimethylolpropane, bistrimethylolpropane, pentaerythritol and sorbitol, and from polyepichlorohydrins.

However, they are also derived, for example, from cycloaliphatic alcohols, such as 1,3- or 1,4-dihydroxycyclohexane, bis-(4-hydroxycyclohexyl)-methane, 2,2-bis-(4-hydroxycyclohexyl)-propane or 1,1-bis-(hydroxymethyl)-cyclohex-3-ene, or they have aromatic nuclei, such as N,N-bis-(2-hydroxyethyl)-aniline or p,p′-bis-(2-hydroxyethyl-amino)-diphenylmethane.

The epoxide compounds may also be derived from mononuclear phenols, such as, for example, from resorcinol or hydroquinone; or they are based on polynuclear phenols, such as, for example, on bis-(4-hydroxyphenyl)-methane, 2,2-bis-(4-hydroxyphenyl)-propane, 2,2-bis-(3,5-dibromo-4-hydroxyphenyl)-propane or 4,4′-dihydroxydiphenyl sulfone, or on condensation products of phenols with formaldehyde which are obtained under acidic conditions, such as phenol-novolaks.
2. Difunctional, cycloaliphatic epoxide-containing compounds which contain the structural fragment shown in (6)

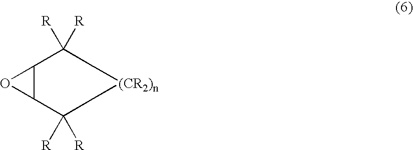

In formula (6), R in each case independently of one another may be chosen from the group consisting of H, alkyl, aryl, halogen, halogenoalkyl, alkoxy, carboalkoxy and carbonyl, and n may be chosen from 0 to 8, preferably 0 to 2.

Preferred examples from the class of cycloaliphatic epoxide-containing compounds which may optionally be employed according to the invention are 3,4-epoxycyclohexyl 3,4-epoxycyclohexylcarboxylate (commercial product ERL 4221 from Union Carbide), bis-(3,4-epoxycyclohexylmethyl)adipate, vinylcyclohexene diepoxide, 3,4-epoxy-6-methyl-cyclohexylmethyl 3′,4′-epoxy-6′-methylcyclohexanecarboxylate, 2,3-epoxycyclohexyl 3,4-epoxycyclohexyl-carboxylate, 4-(3,4-epoxy-5-methylcyclohexyl)-butyl 3′,4′-epoxycyclohexyl-carboxylate and 3,4-epoxy-cyclohexyl-ethylene oxide.
3. Poly-(N-glycidyl) compounds obtainable by dehydrochlorination of the reaction products of epichlorohydrin with amines. These amines are, for example, aniline, toluidine, n-butylamine, bis-(4-aminophenyl)-methane, m-xylylenediamine or bis-(4-methylaminophenyl)-methane, but also N,N,O-triglycidyl-m-aminophenol or N,N,O-triglycidyl-p-aminophenol.

The poly-(N-glycidyl) compounds also include, however, N,N′-diglycidyl derivatives of cycloalkylene-ureas, such as ethylene-urea or 1,3-propylene-urea, and N,N′-diglycidyl derivatives of hydantoins, such as of 5,5-dimethylhydantoin.

Nitrogen compounds which may preferably be employed are also nitrogen-containing heterocyclic compounds, such as triazines, barbituric acids, hydantoins, uracils, pyromellitic acid diimides, piperidines, piperazines, piperazinediones and isocyanurates.

The thermoplastic molding compositions may comprise as component H) a filler or reinforcing substance or a mixture of two or more different fillers and/or reinforcing substances, for example based on talc, mica, silicate, quartz, titanium dioxide, wollastonite, kaolin, amorphous silicas, magnesium carbonate, chalk, feldspar, barium sulfate and glass beads, and/or fibrous fillers and/or reinforcing substances based on carbon fibers and/or glass fibers. Mineral particulate fillers based on talc, mica, silicate, quartz, titanium dioxide, wollastonite, kaolin, amorphous silicas, magnesium carbonate, chalk, feldspar, barium sulfate and/or glass fibers are preferably employed. According to the invention, mineral particulate fillers based on talc, wollastonite and/or glass fibers are particularly preferred. Fillers based on talc are most preferred.

For uses in particular in which isotropy in the dimensional stability and a high thermal dimensional stability is required, such as, for example, in motor vehicle uses for vehicle body exterior components, mineral fillers are preferably employed, particularly preferably talc, wollastonite or kaolin.

Needle-shaped mineral fillers are also particularly preferred. According to the invention, needle-shaped mineral fillers are understood as meaning a mineral filler with a highly pronounced needle-shaped character. Needle-shaped wollastonites may be mentioned as an example. The mineral preferably has a length:diameter ratio of 2:1 to 35:1, particularly preferably 3:1 to 19:1, most preferably 4:1 to 12:1. The average particle size of the needle-shaped minerals according to the invention is preferably less than 20 μm, particularly preferably less than 15 μm, especially preferably less than 10 μm, most preferably less than 5 μm, as determined with a CILAS Granulometer.

Mineral fillers based on talc are most preferred as component H). In the context of the invention, possible mineral fillers based on talc are all the particulate fillers which the expert associates with talc or talcum. All the particulate fillers which are commercially available and have product descriptions which contain the terms talc or talcum as characterizing features are also possible.

Mineral fillers which have a content of talc according to DIN 55920 of greater than 50 wt. %, preferably greater than 80 wt. %, particularly preferably greater than 95 wt. % and especially preferably greater than 98 wt. %, based on the total weight of filler, are preferred.

The mineral fillers based on talc may also be treated on the surface. For example, they may be finished with an adhesion promoter system e.g. based on silane. The mineral fillers to be employed according to the invention which are based on talc preferably have an upper particle or grain size d97 of less than 50 μm, preferably less than 10 μm, particularly preferably less than 6 μm and especially preferably less than 2.5 μm. The average particle size d50 chosen is preferably a value of less than 10 μm, preferably less than 6 μm, particularly preferably less than 2 μm and especially preferably less than 1 μm. The d97 and d50 values of the fillers are determined by SEDIGRAPH D 5 000 sedimentation analysis or by DIN 66 165 sieve analysis.

The average aspect ratio (diameter to thickness) of the particulate fillers based on talc is preferably in the range from 1 to 100, particularly preferably 2 to 25 and especially preferably 5 to 25, determined on electron microscopy photographs of ultra-thin sections of the finished products and by measurement of a representative amount (approx. 50) of filler particles.

The filler and/or reinforcing substance may optionally be modified on the surface, for example with an adhesion promoter or adhesion promoter system, e.g. based on silane. However, the pretreatment is not absolutely necessary. In particular, if glass fibers are used polymer dispersions, film-forming agents, branching agents and/or glass fiber processing auxiliaries may also be used in addition to silanes.

According to the invention, glass fibers which in general have a fiber diameter of between 7 and 18 μm, preferably between 9 and 15 μm, may also be particularly preferably employed. These may be added as continuous fibers or as cut or ground glass fibers, it being possible for the fibers to be finished with a suitable size system and an adhesion promoter or adhesion promoter system, e.g. based on silane.

Customary silane compounds for pretreatment with a size system have, for example, the general formula
(X—(CH₂)_{q})ₖ—Si—(O—CᵣH₂ᵣ₊₁)₄₋ₖ
in which the substituents have the following meaning:
x NH₂—, HO—, 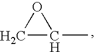
q an integer from 2 to 10, preferably 3 to 4
r an integer from 1 to 5, preferably 1 to 2
k an integer from 1 to 3, preferably 1.

Preferred silane compounds are aminopropyltrimethoxysilane, aminobutyltrimethoxysilane, aminopropyltriethoxysilane, aminobutyltriethoxysilane and the corresponding silanes which contain a glycidyl group as the substituent X.

The silane compounds may in general be employed for the surface coating in amounts of 0.05 to 2 wt. %, preferably 0.5 to 1.5 wt. % and in particular 0.8 to 1 wt. %, based on the mineral filler.

Due to the processing to give the molding composition or shaped article, the particulate fillers may have a lower d97 or d50 value in the molding composition or in the shaped article than the fillers originally employed. Due to the processing to give the molding composition or shaped article, the glass fibers may have shorter length distributions in the molding composition or in the shaped article than originally employed.

The particle diameter in the finished product may be determined here, for example, by recording electron microscopy photographs of thin sections of the polymer mixture and using at least 25, preferably at least 50 filler particles for the evaluation.

The compositions according to the invention may furthermore comprise as component I) conventional additives, which in general may be added in amount of up to 15 wt. %, preferably in an amount of 0.01 to 10 wt. %, particularly preferably 0.05 to 5 wt. %, especially preferably 0.1 to 3 wt. %, based on the total weight of the molding compositions.

All the conventional additives, such as e.g. stabilizers (for example heat stabilizers), antistatics, flow agents, mould release agents, fireproofing additives, emulsifiers, nucleating agents, plasticizers, lubricants, additives which lower the pH (e.g. compounds containing carboxyl groups) and additives for increasing the conductivity may be possible here. The additives mentioned and further suitable additives are described, for example, in Gächter, Müller, Kunststoff-Additive, 3rd edition, Hanser-Verlag, Munich, Vienna, 1989. The additives may be employed by themselves or as a mixture or in the form of masterbatches. The additives may be admixed and/or applied to the surface.

Stabilizers which may be employed are, for example, sterically hindered phenols and/or phosphites, hydroquinones, aromatic secondary amines, such as diphenylamines, substituted resorcinols, salicylates, benzotriazoles and benzophenones, and variously substituted representatives of these groups and mixtures thereof.

Nucleating agents which may be employed are e.g. sodium phenyl phosphinate, aluminium oxide, silicon dioxide and, preferably talc and the nucleating agents described above.

Lubricants and mould release agents which may be employed are ester waxes, pentaerithrityl stearate (PETS), long-chain fatty acids (e.g. stearic acid or behenic acid), their salts (e.g. Ca or Zn stearate) and amide derivatives (e.g. ethylene-bis-stearylamide) or montan waxes (mixtures of straight-chain, saturated carboxylic acids having chain lengths of 28 to 32 C atoms) and low molecular weight polyethylene or polypropylene waxes.

Plasticizers which may be employed are, for example, phthalic acid dioctyl ester, phthalic acid dibenzyl ester, phthalic acid butyl benzyl ester, hydrocarbon oils and N-(n-butyl)benzenesulfonamide.

In order to obtain conductive molding compositions, carbon blacks, conductivity blacks, carbon fibrils, nanoscale graphite fibers (nanotubes), graphite, conductive polymers, metal fibers and other conventional additives for increasing the conductivity may be added.

Flameproofing agents which may be employed are commercially available organic halogen compounds with synergists or commercially available organic nitrogen compounds or organic/inorganic phosphorus compounds, individually or in a mixture. Mineral flameproofing additives, such as magnesium hydroxide or Ca/Mg carbonate hydrates (e.g. DE-A 4 236 122) may also be employed. Examples of halogen-containing, in particular brominated and chlorinated compounds which may be mentioned are: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate and brominated polystyrene. Suitable organic phosphorus compounds are the phosphorus compounds according to WO-A 98/17720, e.g. triphenyl phosphate (TPP), resorcinol bis-(diphenyl phosphate), including oligomers, and bisphenol A bis-diphenyl phosphate, including oligomers (cf. e.g. EP-A 0 363 608 and EP-A 0 640 655), melamine phosphate, melamine pyrophosphate, melamine polyphosphate and mixtures thereof. Possible nitrogen compounds are, in particular, melamine and melamine cyanurate. Suitable synergists are e.g. antimony compounds, in particular antimony trioxide and antimony pentoxide, zinc compounds, tin compounds, such as e.g. tin stannate, and borates. Carbon-forming agents and tetrafluoroethylene polymers may be added. The flameproofing agents, optionally with a synergist, such as antimony compounds, and antidripping agents, are in general employed in an amount of up to 30 wt. %, preferably 20 wt. % (based on the total composition).

Reinforcing substances, e.g. in the form of glass fibers, may also be added as additives.

The invention furthermore provides a process for the preparation of the compositions, the use of the composition according to the invention for the production of semi-finished products and moldings and semi-finished products and moldings produced therefrom.

The compositions according to the invention are prepared by known processes by mixing the components. It may be advantageous to premix individual components. The premixing may take place here both as a dry blend and by joint kneading, extrusion or milling of the components. Mixing in of individual components, in particular stabilizers, additives and coloring agents, may furthermore already be carried out during synthesis of the polymers employed according to the invention. Mixing of components A to D and further constituents is preferably effected at temperatures of 220 to 330° C. by joint kneading, extrusion or milling of the components.

The compositions according to the invention may be processed to all types of semi-finished products or molding by conventional processes. Examples of processing processes which may be mentioned are extrusion processes and injection molding processes. Examples of semi-finished products which may be mentioned are films and sheets.

Because of the high color homogeneity, the moldings are particularly suitable for uses which are visually and optically important. According to the invention, the moldings may be employed in a non-lacquered form or in a form coated with a transparent clear lacquer system. However, the moldings may of course also be lacquered with a coloring base lacquer. The moldings may be small or large components and may be employed for exterior or interior uses. Preferably, large-component moldings are produced for vehicle construction, in particular the automobile sector. In particular, vehicle body exterior components, such as e.g. mud guards, tail gates, engine bonnets, bumpers, loading areas, covers for loading areas, car roofs, air intake grills, spoilers or other vehicle body components, may be produced from the molding compositions according to the invention.

Moldings or semi-finished products from the molding compositions/compositions according to the invention may also be in a composite with further materials, such as e.g. metal or plastic. The molding compositions according to the invention or the moldings/semi-finished products from the molding compositions according to the invention may be employed in a composite with other materials or with themselves for the production of finished components, such as e.g. vehicle body exterior components, by conventional techniques of bonding and joining of several components or parts, such as e.g. coextrusion, injection molding under films, injection molding around embedded components, gluing, welding, screwing or clamping.

The molding compositions according to the invention may also be used for numerous further uses. Examples which may be mentioned are the use in electrical and electronics engineering and in the construction sector. Moldings from the molding compositions according to the invention may be used in the fields of use mentioned, for example, as lamp covers, as safety panes, as housing material for electronic apparatuses, as housing material for domestic appliances and as sheets for the production of covers.

The compositions according to the invention are distinguished by a very good color homogeneity and by a very good stability to weathering. They moreover fulfil high requirements with regard to processing stability, flowability of the melt, toughness, toughness at low temperatures, rigidity, heat distortion point, thermal expansion, surface quality, lacquerability, resistance to chemicals and resistance to fuels.

### EXAMPLES

Component A

Polybutylene terephthalate type A1: Component A is polybutylene terephthalate having an intrinsic viscosity IV of 0.93 cm³/g, commercial product Pocan® B 1300 from Bayer AG, Leverkusen.

The intrinsic viscosity is measured in phenol/o-dichlorobenzene (1:1 parts by wt.) at 25° C.

Component B

Polycarbonate type B1:

Linear polycarbonate (Makrolon® 2405 from Bayer AG, Leverkusen, Germany) based on bisphenol A having a viscosity ηrel. of approx. 1.29 (measurement conditions: 5 g polycarbonate per litre of methylene chloride, 25° C.) and a molecular weight Mw of approx. 29,000 g/mol (determined with GPC methods against a polycarbonate standard).

Component-C1

Component C1 is Paraloid® EXL 2650 from Rohm und Haas Deutschland GmbH, Frankfurt.

Component C2

Component C2 is a graft copolymer of acrylonitrile and styrene on a graft base of polybutadiene, intermediate product of Bayer AG, Leverkusen having a polybutadiene content of 75 wt. % and a styrene content in the shell of 28 wt. %.

Comparison component VI

Comparison component VI is the AES rubber Royaltu® 970 E (former name Blendex® WX 270) from Crompton Corporation, Crompton GmbH Deutschland, Bergkamen.

Component D1

Component D1 is a graft copolymer of acrylonitrile and styrene on a graft base of partly crosslinked polybutyl acrylate, Centrex® 57 WBA, intermediate product of Lanxess Corp. Pittsburgh.

Component D2

Component D2 is Paraloid® EXL 3361 (a core-shell-impact modifier based on a partly crosslinked core of acrylate) from Rohm & Haas Deutschland, Frankfurt.

Component E

Component E is Tinuvin® 350 from Ciba Geigy, Basle.

Component F

Component F is carbon black, type Black Pearls® 800 from Cabot GmbH, Hanau.

Component G

Component G is Araldit® GT 7071 (a hydrolysis stabilizer based a Phenol-Epichlorhydrine-reaction product) from Huntsman Advanced Materials Deutschland GmbH, Bergkamen.

In addition, commercially available processing auxiliaries are employed as additives.

Compounding operations were carried out on a twin-screw extruder of the type ZSK32 (Werner und Pfleiderer) at melt temperatures of 250 to 290° C.

The test specimens were injection molded on an injection molding machine of the type Arburg 320-210-500 at melt temperatures of 260 to 280° C. and mold temperatures of 70 to 90° C.

The molding compositions according to the invention were tested by the following methods:

Vicat B: Heat distortion stability or heat distortion point in accordance with DIN ISO 306/B 120 in silicone oil.

Izod impact strength: Toughness in accordance with ISO 180 method 1 U at −30° C.

Izod notched impact strength: Toughness in accordance with ISO 180 method 1 A at 23° C.

Tensile E modulus and tensile strength in accordance with DIN/EN ISO 527-2/1A.

MVR: Flowability in accordance with DIN/ISO 1133 at 260° C. and 5 kg.

Color homogeneity: Determination of the color homogeneity of the surface by visual assessment.

“+” means a homogeneous coloration without the formation of stripes of lower color intensity perpendicular to the direction of flow (tiger stripes)

“0” means a largely homogenous coloration with slight formation of stripes of lower color intensity perpendicular to the direction of flow

“−” means an inhomogeneous coloration with severe formation of stripes perpendicular to the direction of flow.

The evaluation of the color homogeneity was carried out on sheets of 150×105×1.6 mm, which were produced with a melt temperature of 270° C., a mold temperature of 80° C. and a filling rate of 50 mm/s via a film gate on a 105 mm side.

As may be seen from table 1, the molding compositions according to the invention have the required combination of very good color homogeneity and good stability to hydrolysis (>60% of initial strength after hydrolysis) with simultaneously good mechanical properties. Compared with comparison examples 2 and 3, the molding compositions according to the invention moreover are significantly more stable to LW, because the content of UV-sensitive components C is significantly lower.

The composition and properties of the thermoplastic molding compositions according to the invention may be seen from Table 1.

TABLE 1

| Examples | | Ex. 1 | Ex. 2 | Ex. 3 | Comp. 1 | Comp. 2 | Comp. 3 | Comp. 4 | Comp. 5 | Comp. 6 |
|---|---|---|---|---|---|---|---|---|---|---|
| Component A, | [%] | 35.9 | 35.9 | 34.4 | 34.4 | 34.4 | 35.9 | 35.9 | 35.9 | 35.9 |
| PBT | | | | | | | | | | |
| Component B, | [%] | 50.0 | 50.0 | 50.0 | 50.0 | 50.0 | 50.0 | 50.0 | 50.0 | 50.0 |
| PC | | | | | | | | | | |
| Component C1 | [%] | 6 | — | 6 | — | 12 | — | — | — | — |
| Component C2 | [%] | — | 6 | — | — | — | 12 | — | — | — |
| Component V1 | [%] | — | — | — | 6 | — | — | 12 | — | — |
| Component D1 | [%] | 6 | 6 | — | — | — | — | — | 12 | — |
| Component D2 | [%] | — | — | 6 | 6 | — | — | — | — | 12 |
| Component E | [%] | 0.3 | 0.3 | 0.3 | 0.3 | 0.3 | 0.3 | 0.3 | 0.3 | 0.3 |
| Component F | [%] | 1.5 | 1.5 | 1.5 | 1.5 | 1.5 | 1.5 | 1.5 | 1.5 | 1.5 |
| Component G | [%] | 1.5 | 1.5 | 1.5 | 1.5 | 1.5 | 1.5 | 1.5 | 1.5 | 1.5 |
| Additives | [%] | 0.3 | 0.3 | 0.3 | 0.3 | 0.3 | 0.3 | 0.3 | 0.3 | 0.3 |
| Vicat B | [%] | 116 | 116 | 114 | 119 | 91 | 114 | 115 | 119 | 120 |
| Izod impact | [kJ/m²] | not | not | 9 x not | 9 x not | not | not | 9 x not | not | 9 x not |
| strength −30° C. | | broken | broken | broken | broken | broken | broken | broken | broken | broken |
| | | | | 1 × 120 | 1 × 47 | | | 1 × 128 | | 1 × 139 |
| Izod notched | [kJ/m²] | 31.4 | 34.9 | 20 | 38 | 32.7 | 40.4 | 37.7 | 16.1 | 42.9 |
| impact strength | | | | | | | | | | |
| 23° C. | | | | | | | | | | |
| Tensile | [MPa] | 2270 | 2270 | 2220 | 2230 | 2130 | 2230 | 2230 | 2340 | 2170 |
| modulus | | | | | | | | | | |
| Tensile strength | [MPa] | 57.1 | 55.2 | 57 | 52.7 | 55 | 54.6 | 50.8 | 56.6 | 54.8 |
| Tensile strength | [MPa] | 46.1 | 38.1 | 58.2 | 34.3 | 59.5 | 39.9 | 14.2 | 58.0 | 56.4 |
| after hydrolysis | | | | | | | | | | |
| (100% r.h., | | | | | | | | | | |
| 100° C., 10 d) | | | | | | | | | | |
| MVR | [cm³/10 mm] | 19.3 | 15.0 | 21.7 | 21.3 | 12.4 | 18.2 | 17.4 | 12.9 | 22 |
| (260° C./5 kg) | | | | | | | | | | |
| Color | | + | + | 0 | − | + | + | − | 0 | 0 |
| homogeneity | | | | | | | | | | |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A thermoplastic molding composition comprising
A) 4 to 80 parts by wt. of at least one polyalkylene terephthalate,
B) 10 to 90 parts by wt. of at least one aromatic polycarbonate,
C) 1.5 to 30 parts by wt. of at least one graft polymer based on rubber-elastic olefinically unsaturated olefin (co)polymers as the rubber component,
D) 1.5 to 30 parts by wt. of at least one graft polymer based on acrylate as the rubber component,
E) 0.01 to 5 parts by wt. of a UV stabilizer,
F) 0.01 to 10 parts by wt. of a coloring agent,
G) 0 to 5 parts by wt. of an hydrolysis stabilizer,
H) 0 to 54 parts by wt. of at least one particulate mineral filler,
I) 0 to 10 parts by wt. of at least one further additives.

2. A composition according to claim 1, wherein C) is a graft polymer of
C1) 5 to 95 wt. % relative to the weight of the graft polymer of at least one vinyl monomer grafted on
C2) 95 to 5 wt. % relative to the weight of the graft polymer of one or more rubber-elastic olefinically unsaturated olefin (co)polymers as graft bases having glass transition temperatures equal to or lower than 10° C.

3. A composition according to claim 1, wherein C) is a graft polymer based on polybutadiene as the rubber component.

4. The composition according to claim 1 wherein D) is a graft polymer of
D1) 5 to 95 wt. % relative to the weight of the graft polymer of at least one vinyl monomer grafted on
D2) 95 to 5 wt. % relative to the weight of the graft polymer of one or more acrylate rubber graft bases having glass transition temperatures lower than 10° C.

5. A composition according to claim 1, wherein polyalkylene terephthalate is polyethylene terephthalate.

6. A molded article comprising the composition of claim 1.

7. The article of claim 6 comprising an applied layer of clear lacquer.
